(19) United States
(12) Patent Application Publication
(10) Pub. No.: US 2015/0116718 A1
(43) Pub. Date: Apr. 30, 2015

(54) OPTICAL SENSOR AND IMAGE FORMING APPARATUS INCORPORATING SAME

(71) Applicants: Terumichi OCHI, Kanagawa (JP); Takumi WAIDA, Kanagawa (JP); Shinji KATO, Kanagawa (JP); Toshihiro ISHII, Miyagi (JP); Shuji HIRAI, Tokyo (JP); Takashi FUJITA, Kanagawa (JP); Shinichi NAMEKATA, Kanagawa (JP); Ryota YAMASHINA, Kanagawa (JP); Arinobu YOSHIURA, Kanagawa (JP); Motoyoshi YAMANO, Tokyo (JP)

(72) Inventors: Terumichi OCHI, Kanagawa (JP); Takumi WAIDA, Kanagawa (JP); Shinji KATO, Kanagawa (JP); Toshihiro ISHII, Miyagi (JP); Shuji HIRAI, Tokyo (JP); Takashi FUJITA, Kanagawa (JP); Shinichi NAMEKATA, Kanagawa (JP); Ryota YAMASHINA, Kanagawa (JP); Arinobu YOSHIURA, Kanagawa (JP); Motoyoshi YAMANO, Tokyo (JP)

(21) Appl. No.: 14/512,657

(22) Filed: Oct. 13, 2014

(30) Foreign Application Priority Data
Oct. 24, 2013 (JP) 2013-221143

(51) Int. Cl. G01N 21/47; G03G 15/00

(52) U.S. Cl. CPC G01N 21/4738; G03G 15/5029; G01N 2201/0612; G01N 2201/0633
USPC 356/446; 399/45

(57) ABSTRACT

An optical sensor includes a light-emitting unit to emit light onto a measuring object, a regular reflection light receiver to receive regular reflection light from the measuring object out of the light emitted by the light-emitting unit, and a diffuse reflection light receiver to receive diffuse reflection light from the measuring object out of the light emitted by the light-emitting unit. An angle of incidence of the light emitted onto a surface of the measuring object is not smaller than 75° and not larger than 85°. The diffuse reflection light receiver receives, out of the diffuse reflection light from the measuring object, diffuse reflection light having an angle of reflection with respect to a perpendicular to the surface of the measuring object larger than 0° and smaller than an angle of reflection of the regular reflection light with respect to the perpendicular to the surface of the measuring object.

### CROSS-REFERENCE TO RELATED APPLICATION

This patent application is based on and claims priority pursuant to 35 U.S.C. §119(a) to Japanese Patent Application No. 2013-221143, filed on Oct. 24, 2013, in the Japan Patent Office, the entire disclosure of which is hereby incorporated by reference herein.

### BACKGROUND

1. Technical Field

Embodiments of the present invention generally relate to an optical sensor and to an image forming apparatus incorporating the optical sensor, and more particularly, to a reflective optical sensor that receives regular reflection light and diffuse reflection light out of light emitted from a light-emitting unit and reflected from an object, and to an image forming apparatus, such as a printer, a copier, or a facsimile machine, that incorporates the reflective optical sensor.

2. Background Art

Related-art image forming apparatuses, such as copiers, facsimile machines, printers, or multifunction printers having two or more of copying, printing, scanning, facsimile, plotter, and other capabilities, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a development device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

### SUMMARY

In one embodiment of the present invention, an improved optical sensor is described that includes a light-emitting unit to emit light onto a measuring object, a regular reflection light receiver to receive regular reflection light from the measuring object out of the light emitted by the light-emitting unit, and a diffuse reflection light receiver to receive diffuse reflection light from the measuring object out of the light emitted by the light-emitting unit. An angle of incidence of the light emitted onto a surface of the measuring object is not smaller than 75° and not larger than 85°. The diffuse reflection light receiver receives, out of the diffuse reflection light from the measuring object, diffuse reflection light having an angle of reflection with respect to a perpendicular to the surface of the measuring object larger than 0° and smaller than an angle of reflection of the regular reflection light with respect to the perpendicular to the surface of the measuring object.

Also described is an image forming apparatus incorporating the optical sensor.

### BRIEF DESCRIPTION OF THE DRAWINGS

A more complete appreciation of the disclosure and many of the attendant advantages thereof will be more readily obtained as the same becomes better understood by reference to the following detailed description of embodiments when considered in connection with the accompanying drawings, wherein:

FIG. 1 is a diagram illustrating an air leakage smoothness test;

FIG. 2 is a schematic view of an optical sensor according to an embodiment of the present invention;

FIG. 3 is a block diagram of principal parts of a controller that controls the optical sensor;

FIG. 4 is a flowchart of a detection process using the optical sensor;

FIG. 5 is a graph illustrating distribution of strength of regular reflection light on a recording sheet;

FIG. 6 is a table of a relationship between smoothness and process conditions;

FIG. 7 is a schematic view of an experimental device used for an experiment to find the optimum angle of incidence for detecting smoothness of a recording sheet;

FIG. 8 is a graph of a relationship between angle of detection of regular reflection light and correlation value;

FIG. 9 is a schematic view of the experimental device in a state in which the device is moved away from a recording sheet;

FIG. 10 is a schematic view of an experimental device for confirming the advantageous effect of a lens;

FIG. 11 is a graph of a correlation between gap and diameter of lens of the optical sensor;

FIG. 12 is a diagram illustrating an acceptance angle width of light;

FIG. 13 is a graph of a correlation between angle of detection of regular reflection light and correlation value;

FIG. 14A is a schematic view of an optical sensor employing a configuration in which light scattered by an aperture enters a regular reflection light sensor;

FIG. 14B is a schematic view of an optical sensor employing a configuration in which light scattered by a collimator lens enters a regular reflection light sensor;

FIG. 15 is a graph of measurement results of reflection spectra of recording sheets;

FIG. 16 is a graph illustrating a comparison of correlation values between a first example and a comparative example; and

FIG. 17 is a schematic view of an image forming apparatus according to an embodiment of the present invention.

The accompanying drawings are intended to depict embodiments of the present invention and should not be interpreted to limit the scope thereof The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the invention and all of the components or elements described in the embodiments of the present invention are not necessarily indispensable to the present invention.

In a later-described comparative example, embodiment, and exemplary variation, for the sake of simplicity like reference numerals are given to identical or corresponding constituent elements such as parts and materials having the same functions, and redundant descriptions thereof are omitted unless otherwise required.

Referring now to the drawings, wherein like reference numerals designate identical or corresponding parts throughout the several views, embodiments of the present invention are described below.

Usually, in image forming apparatuses, fixing conditions such as a fixing temperature and pressure for fixing a toner image onto a recording medium are taken into account to enhance image quality, because the image quality is influenced by such factors as the material, thickness, humidity, smoothness, and coating (if any) of the recording medium. For example, with respect to the smoothness, toner may insufficiently attaches to convex portions on the surface of the recording medium depending on the fixing conditions, causing unevenness in image density or color and impairing the image.

Surface conditions of a recording medium such as a sheet of paper can be measured using, e.g., a confocal microscope. However, the surface roughness of the sheet has a steep incline and measurement results may include many noise components. In addition, it takes a long time to complete the measurement. Therefore, in the paper industry, smoothness of a sheet of paper is evaluated based on measurement results obtained by an air leakage smoothness test as an index of the surface conditions of the sheet of paper because the air leakage smoothness test is relatively easy. For example, copiers are developed to optimize printing conditions with the smoothness of sheets of paper as one of standards. As an index that indicates surface conditions of a sheet of paper, the measurement results obtained by the air leakage smoothness test are used rather than an index that indicates general surface conditions such as calculated average roughness (Ra).

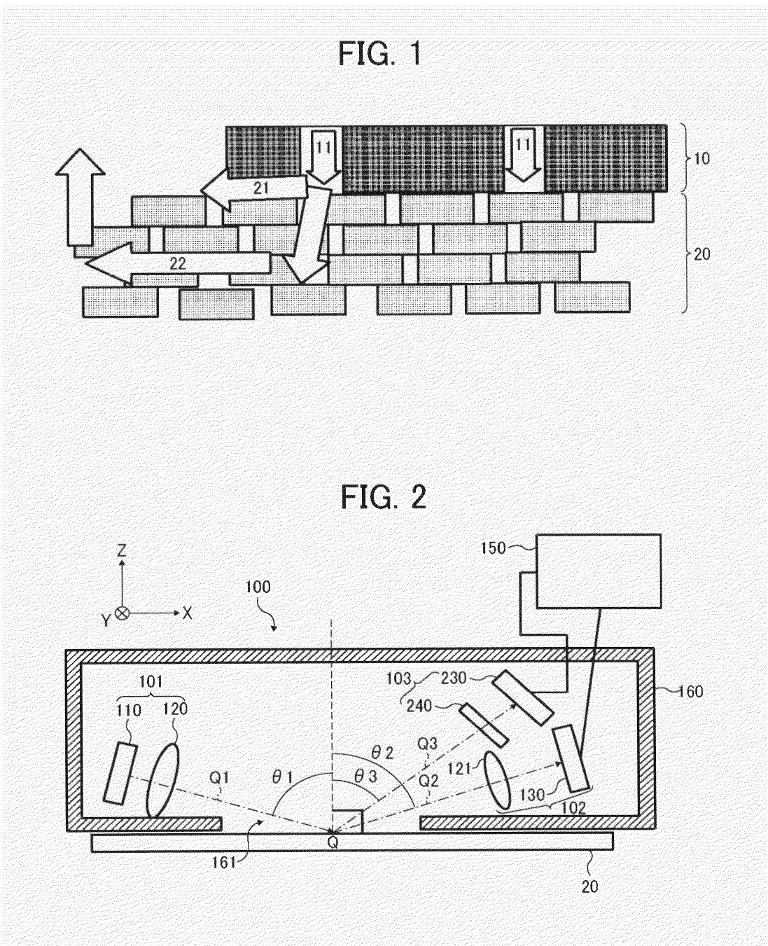

FIG. 1 is a diagram illustrating the air leakage smoothness test.

In the air leakage smoothness test of sheets of paper, air 11 is supplied from a head 10 of an air leak device to a recording sheet 20 serving as a recording medium. The smoothness of the recording sheet 20 is evaluated based on the airflow over time (typically ml/min) during which the air 11 leaks. The air 11 supplied to the recording sheet 20 includes air 21 that leaks from the surface of the recording sheet 20 and air 22 that enters inside the recording sheet 20 and leaks therefrom. The smoothness of the recording sheet 20 is evaluated based on the air leak time.

Although the measurement in the air leakage smoothness test is relatively easy, there are problems such that devices are increasing in size and it takes a long time to complete the test. Therefore, there are increasing demands for inexpensive optical sensors that can be incorporated in image forming apparatuses and that can detect surface conditions (i.e., smoothness) of sheets of paper as in the air leakage smoothness test.

As an example of such optical sensors, there is proposed an optical sensor that facilitates measurement of smoothness using the difference in the amount of regular reflection light among recording media. Specifically, in such an optical sensor, an angle of incidence on the surface of a recording medium is set in a range of 75°≦θ1≦85° to obtain a relatively high correlation between the amount of regular reflection light and the surface smoothness of the recording medium. With the optical sensor, the smoothness of the recording medium is calculated using two kinds of data, the amount of regular reflection light and an amount of diffuse reflection light, to provide more accurate measurement of smoothness of recording media than measurement using just the amount of regular reflection light.

However, the diffuse reflection light used for calculation of smoothness of the recording medium is diffuse reflection light perpendicular to the surface of the recording medium, yet changes in angle of reflection of the diffuse reflection light used for the measurement of smoothness with respect to the perpendicular to the recording medium also changes the degree of correlation between actual smoothness and smoothness calculated from the amount of regular reflection light and the amount of diffuse reflection light. Such changes in angle of reflection of the diffuse reflection light used for the measurement of smoothness with respect to the perpendicular to the recording medium contributes to more accurate measurement of smoothness than measurement with the proposed optical sensor described above.

By contrast, embodiments of the present invention provide an optical sensor capable of measuring smoothness of a measuring object such as a recording medium with a higher accuracy and an image forming apparatus incorporating the optical sensor.

Referring now to FIG. 2, a description is given of an optical sensor 100 according to an embodiment of the present invention.

FIG. 2 is a schematic view of the optical sensor 100.

In the present embodiment, the optical sensor 100 includes a light-emitting unit 101, which includes a light source 110 and a collimator lens 120. The light-emitting unit 101 emits light toward the recording sheet 20 as a measuring object. The emitted light is incident onto the surface of the recording sheet 20 at an angle θ1 not smaller than about 75° and not larger than 85°.

The optical sensor 100 further includes a regular reflection light receiver 102 that detects regular reflection light from the recording sheet 20 and a diffuse reflection light receiver 103 that detects diffuse reflection light from the recording sheet 20. The regular reflection light receiver 102 includes a regular reflection light sensor 130 and a lens 121 through which light reflected from the recording sheet 20 at a predetermined angle enters the regular reflection light sensor 130. The diffuse reflection light receiver 103 includes a diffuse reflection light sensor 230 and a lens 240 through which light reflected from the recording sheet 20 at a predetermined angle enters the diffuse reflection light sensor 230. The regular reflection light sensor 130 and the diffuse reflection light sensor 230 are, e.g., photodiodes.

The optical sensor 100 further includes a housing 160 having an opening 161 in the bottom. The housing 160 accommodates the light source 110, the collimator lens 120, the regular reflection light sensor 130, the diffuse reflection light sensor 230, and the lenses 121 and 240. A controller 150 is connected to the regular reflection light sensor 130 and the diffuse reflection light sensor 230 to control the optical sensor 100. The controller 150 also performs various kinds of processing.

In the present embodiment, the light source 110 is a light emitting diode (LED). Specifically, the light source 110 is an LED chip having an outer shape of about 3 mm square and an emission wavelength of about 850 nm. In short, an infrared LED is employed as the light source 110 to enhance sensitivity of the regular reflection light sensor 130 and the like. Light emission amount of LED is determined by input current. An electronic circuit controls the current to keep it at a rated current of 20 mA. The light source 110 (LED) is secured directly to the housing 160, which is made of, e.g., acrylonitrile, butadiene, and styrene (ABS) resins.

In the present embodiment, the collimator lens 120 is provided because it is preferable to emit accurate collimated light toward the recording sheet 20. The collimator lens 120 has, e.g., a focal length (F) of about 9 mm and a diameter of about 2 mm φ. The collimator lens 120 is disposed such that an emission point of the light source 110 (LED) positions at a focus position of the collimator lens 120. The collimator lens 120 is secured to the housing 160 with a fixed margin of about 0.5 mm. Thus, in the present embodiment, an optical axis Q1 is a line that connects the emission point of the light source 110 (LED) and a center of the collimator lens 120. The light source 110 (LED) and the collimator lens 120 are disposed such that the optical axis Q1 is angled at about 80° with respect to a perpendicular to the recording sheet 20. Specifically, the collimator lens 120 is secured at an appropriate position at which the collimator lens 120 does not contact the recording sheet 20, without excessively enlarging the housing 160.

The regular reflection light sensor 130 is secured inside the housing 160 like the light source 110. In the present embodiment, the regular reflection light sensor 130 is a photodiode (PD) having a size of about 3 mm square and a light detection surface (i.e., light receiving surface) of about 1 mm square. The lens 121, through which light enters the regular reflection light sensor 130 (PD), has, e.g., a focal length (F) of about 9 mm and a diameter of about 3 mm φ. The lens 121 is disposed such that the light receiving surface of the regular reflection light sensor 130 (PD) is positioned at a focus position of the lens 121. Accordingly, an acceptance angle width of light entering the regular reflection light sensor 130 is about 5°. In the present embodiment, an optical axis Q2 is a line that connects a center of the lens 121 and a center of the light receiving surface of the regular reflection light sensor 130 (PD). The regular reflection light sensor 130 and the lens 121 are disposed such that the optical axis Q2 is angled at about 80° with respect to the perpendicular to the recording sheet 20. Accordingly, the lens 121 and the regular reflection light sensor 130 (PD) are inclined with respect to the recording sheet 20.

The diffuse reflection light sensor 230 is secured inside the housing 160 like the light source 110. In the present embodiment, the diffuse reflection light sensor 230 is a photodiode (PD) similar to the regular reflection light sensor 130. The lens 240, through which light enters the diffuse reflection light sensor 230 (PD) is disposed such that a light receiving surface of the diffuse reflection light sensor 230 (PD) is positioned at a focus position of the lens 240. Accordingly, an acceptance angle width of light entering the diffuse reflection light sensor 230 is about 2°. In the present embodiment, an optical axis Q3 is a line that connects a center of the lens 240 and a center of the light receiving surface of the diffuse reflection light sensor 230 (PD). The diffuse reflection light sensor 230 and the lens 240 are disposed such that the optical axis Q3 is angled at about 68° with respect to the perpendicular to the recording sheet 20. Accordingly, the lens 240 and the diffuse reflection light sensor 230 (PD) are inclined with respect to the recording sheet 20.

In the present embodiment, the measuring object of the optical sensor 100 is the recording sheet 20 serving as a recording medium that records an image. Alternatively, another measuring object that requires measurement of smoothness may be detected. In the following description, the recording sheet 20 is described as an example of a measuring object.

The recording sheet 20 is conveyed by, e.g., a conveyor roller along a guide. Accordingly, the optical sensor 100 and the recording sheet 20 keep a constant distance apart. A position at which the optical axis Q1 and the optical axis Q2 intersect is herein referred to as a focus position Q. The focus position Q is formed at a position of about 500 μm inward from a surface defined by the bottom of the housing 160. Accordingly, the recording sheet 20 conveyed along the bottom of the housing 160 is about 500 μm away from the focus position Q.

The optical sensor 100 emits light toward the recording sheet 20 through the opening 161 of the housing 160, and receives regular reflection light and part of diffuse reflection light from the recording sheet 20 with the regular reflection light sensor 130 and the diffuse reflection light sensor 230, respectively. The housing 160 is made of black ABS resins that absorbs light, and removes ambient light. The size of the housing 160 depends on the sizes of the collimator lens 120 and the lenses 121 and 240. The housing 160 has lengths of, e.g., about 50 mm, 10 mm, and 6 mm in directions X, Y, and Z, respectively.

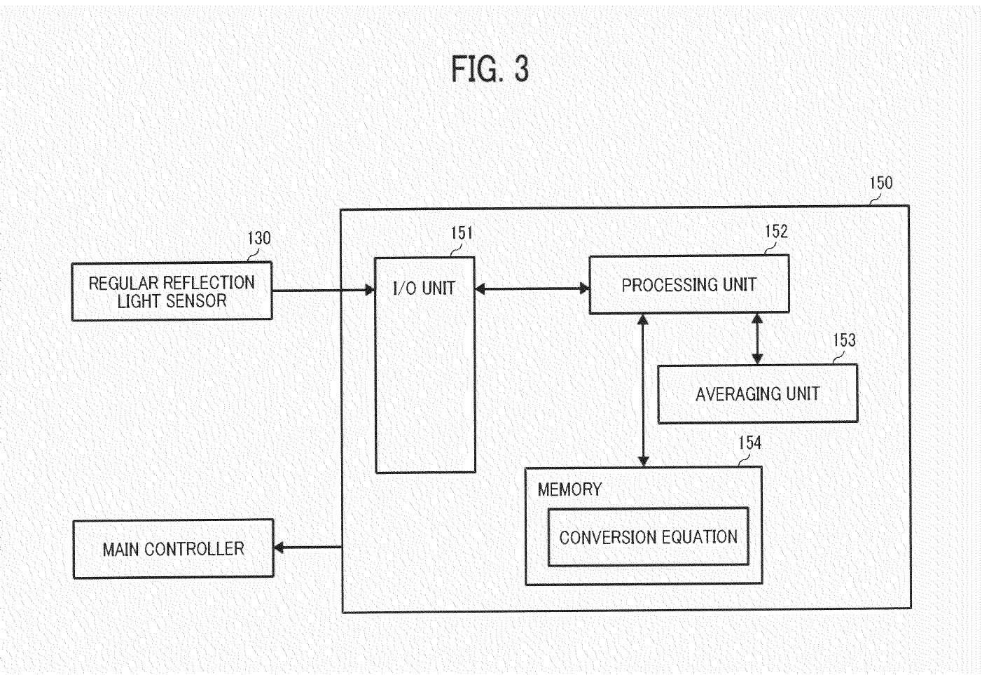

Referring now to FIG. 3, a description is given of the controller 150 that controls the optical sensor 100.

FIG. 3 is a block diagram of principal parts of the controller 150.

The controller 150 is connected to, e.g., the regular reflection light sensor 130 and the diffuse reflection light sensor 230 of the optical sensor 100. The controller 150 includes an input and output (I/O) unit 151, a processing unit 152, an averaging unit 153, and a memory 154. The I/O unit 151 controls input and output of signals from the regular reflection light sensor 130 and the diffuse reflection light sensor 230. The processing unit 152 carries out various operations such as signal processing. The averaging unit 153 performs averaging. The memory 154 stores various kinds of information.

The controller 150 is also connected to, e.g., a main controller of an image forming apparatus. In the present embodiment, the optical sensor 100 includes the controller 150. Alternatively, the controller 150 may be disposed inside the image forming apparatus, if the image forming apparatus includes the optical sensor 100, to control the optical sensor 100.

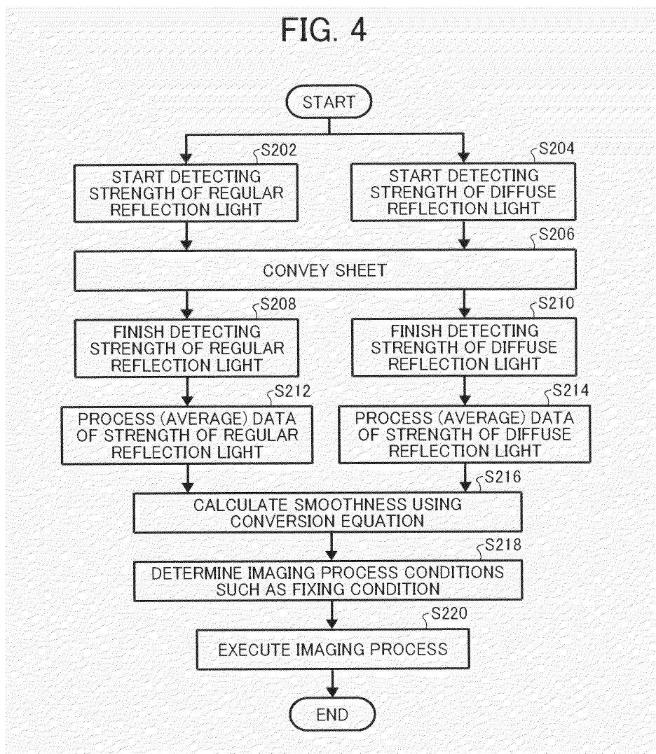

Referring now to FIG. 4, a description is given of a detection process performed by the optical sensor 100.

FIG. 4 is a flowchart of a detection process using the optical sensor 100.

First, an operation is started to detect the strength of regular reflection light using the optical sensor 100 in step 202 (S202). Specifically, by turning on the power or sending a signal that informs the image forming apparatus connected to the optical sensor 100 of the start of a print job, the operation is started to detect the strength of regular reflection light.

Similarly, an operation is started to detect the strength of diffuse reflection light using the optical sensor 100 in step 204 (S204). Specifically, by turning on the power or sending the signal that informs the image forming apparatus connected to the optical sensor 100 of the start of a print job, the operation is started to detect the strength of diffuse reflection light.

Then, the recording sheet 20 is conveyed in step 206 (S206). The recording sheet 20 thus conveyed is irradiated with the light emitted by the light source 110 via the collimator lens 120. The regular reflection light from the recording sheet 20 enters the regular reflection light sensor 130. The diffuse reflection light from the recording sheet 20 enters the diffuse reflection light sensor 230.

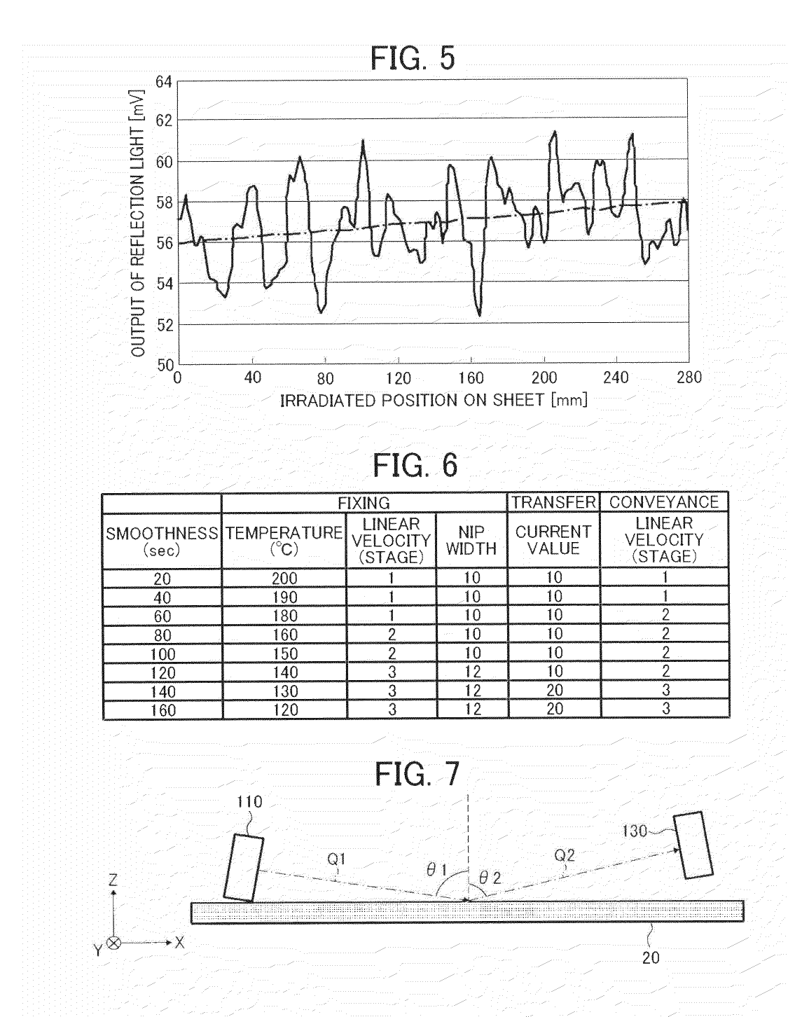

By irradiating the recording sheet 20 with the light while the recording sheet 20 is moving, the regular reflection light and the diffuse reflection light can be detected from one end of the recording sheet 20 to the other end of the recording sheet 20. Specifically, for example, an amount of regular reflection light can be measured at an irradiated position of the recording sheet 20, as illustrated in FIG. 5.

FIG. 5 illustrates a fluctuated wave depicting the amount of regular reflection light, which is advantageous for identifying the kind of recording medium when the wave shows a particular pattern indicative of the kind of recording medium. Similarly, an amount of diffuse reflection light can be measured at an irradiated position of the recording sheet 20. A fluctuated wave depicting the amount of diffuse reflection light is advantageous for identifying the kind of recording medium when the wave shows a particular pattern indicative of the kind of recording medium. Particularly, the diffuse reflection light that the diffuse reflection light sensor 230 receives is advantageous for identifying the kind of recording medium because it includes inner scattered light. The inner scattered light is light entering inside the recording sheet 20 and scattered therein, a polarizing direction of which is rotated.

The optical sensor 100 determines, e.g., the kind of recording sheet 20 using two kinds of data, the amount of regular reflection light provided by the regular reflection light sensor 130 and the amount of diffuse reflection light provided by the diffuse reflection light sensor 230. Accordingly, the optical sensor 100 determines, e.g., the kind of recording sheet 20 more accurately than a typical optical sensor.

Referring back to the process of FIG. 4, the measurement of the strength of regular reflection light is completed in step 208 (S208), and a measurement result is transmitted to the controller 150. Similarly, the measurement of the strength of diffuse reflection light is completed in step 210 (S210), and a measurement result is transmitted to the controller 150.

The controller 150 averages the strength of regular reflection light detected by the regular reflection light sensor 130 in step 212 (S212). Specifically, the averaging unit 153 of the controller 150 performs averaging. Similarly, the controller 150 averages the strength of diffuse reflection light detected by the diffuse reflection light sensor 230 in step 214 (S214). Specifically, the averaging unit 153 of the controller 150 performs averaging.

Then, in step 216 (S216), the controller 150 calculates the smoothness using the strength of regular reflection light and the strength of diffuse reflection light thus averaged. Specifically, the processing unit 152 of the controller 150 calculates smoothness Y from the light strength using a predetermined conversion equation stored in the memory 154 of the controller 150. For example, the conversion equation can be expressed in a general equation such as that below:

Y=a−X1+b×X2+c (1)

where X1 (mV) represents the strength of regular reflection light detected by the regular reflection light sensor 130, X2 (mV) is the strength of diffuse reflection light detected by the diffuse reflection light sensor 230, and a, b, and c are constants determined by, e.g., experiment. In the present embodiment, the constants a, b, and c were determined by an experiment described later. The smoothness Y (sec) is calculated using a conversion equation of Y=0.28×X1−1.11×X2+57.09, for example.

Then, according to the smoothness thus calculated, the controller 150 determines an appropriate image process condition upon fixing (i.e., fixing condition) for forming an image on the recording sheet 20 in the image forming apparatus in step 218 (S218). Specifically, the controller 150 determines a condition closest to the calculated smoothness as the fixing condition according to the relationship between smoothness and process conditions illustrated in FIG. 6, which is stored in the memory 154 of the controller 150.

Then, an imaging process is performed in the image forming apparatus to form an image on the recording sheet 20 in step 220 (S220).

Thus, the smoothness can be detected using the optical sensor 100. According to the smoothness thus detected, printing conditions of the image forming apparatus can be set.

Referring now to FIG. 7, a detailed description is given of the optical sensor 100.

FIG. 7 is a schematic view of an experimental device used for an experiment to find the optimum angle of incidence for detecting the smoothness of the recording sheet 20.

In the experiment, the light source 110, the regular reflection light sensor 130, and the recording sheet 20 were disposed such that light emitted by the light source 110 was reflected from the recording sheet 20 and entered the regular reflection light sensor 130, and that an angle of incidence θ1 and an angle of detection θ2 were the same. Specifically, the angle of incidence θ1 was an angle of optical axis Q1 with respect to the perpendicular to the surface of the recording sheet 20, in which the optical axis Q1 is an optical axis of light incident onto the recording sheet 20 from the light source 110. The angle of detection θ2 was an angle of optical axis Q2 of light reflected from the recording sheet 20 and entering the regular reflection light sensor 130.

The angle of incidence θ1 and the angle of detection θ2 were changed from 60° to 90°. Simultaneously, the light source 110 and the regular reflection light sensor 130 were moved such that the angle of incidence θ1 and the angle of detection θ2 were the same. A photogoniometer with high accuracy was used for measurement. A laser diode (LD) was used as the light source 110 of the experimental device. A collimator lens was used to generate collimated beams having a diameter of about 1 mm. A photodiode (PD) having a detection area of about 2 mm square was used as the regular reflection light sensor 130. A lens was used through which light entered the regular reflection light sensor 130 (PD). An acceptance angle width of the light entering the regular reflection light sensor 130 was set about 0.5°. The angle of incidence θ1 and the angle of detection θ2 were changed per 0.1°. Light-emission strength was settled with a constant current value of the light source 110 (LD). The light entering the regular reflection light sensor 130 (PD) was converted to a current according to a light amount, and converted to a voltage by an operational amplifier. By reading the voltage value, the amount of light entering the regular reflection light sensor 130 (PD) was detected.

In the experiment, 30 kinds of plain paper substantially the same as those in the market were selected as the recording sheets 20. The smoothness of sheets of such plain paper sheets was measured in advance using a smoothness measuring device as illustrated in FIG. 1. An area of a sheet of plain paper where the smoothness was measured and an area of the sheet of plain paper measured with the photogoniometer were substantially the same.

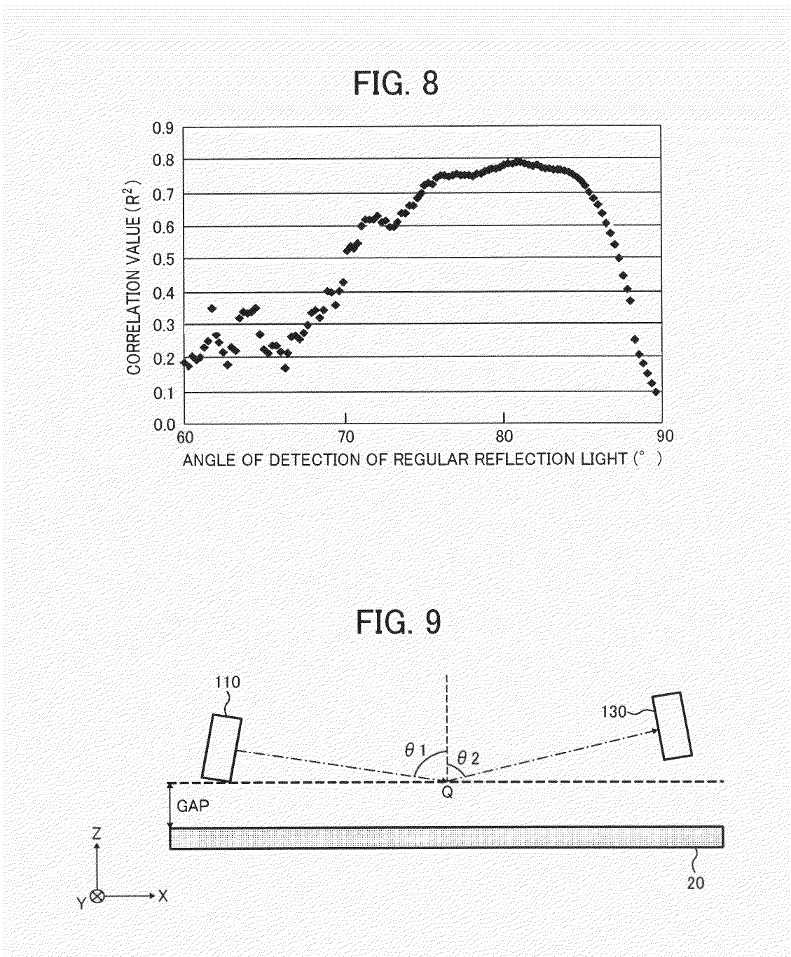

FIG. 8 is a graph of a relationship between angle of detection of regular reflection light and correlation value.

In the graph, the horizontal axis indicates a detection angle as a representative of the angle of incidence θ1 and the angle of detection θ2. The vertical axis indicates a correlation value calculated by a predetermined correlation function. It is to be noted that a larger correlation value indicates that the smoothness Y (sec) calculated from an amount X of the regular reflection light detected by the regular reflection light sensor 130 is closer to the smoothness measured in advance in the air leakage smoothness test. In the experiment, a conversion equation of Y=0.46×X+19.8 was used to calculate the smoothness Y (sec) from the amount X of the regular reflection light detected by the regular reflection light sensor 130. The correlation value was calculated by the following formula:

$$\frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} \qquad ( 2 )$$

where “xᵢ” is smoothness of i-th kind of paper sheet, “yᵢ” is a sensor output of the i-th kind of paper sheet, “ x̅” is an average smoothness of a 30th kind of paper sheet, “ y̅” is an average sensor output of the 30th kind of paper sheet, “n” is 30 (the number of kinds of paper), and “i” is integers from 1 to 30.

As illustrated in FIG. 8, the correlation value shows a peak value near 0.8 at an angle of 80°. On the other hand, the correlation value is about 0.7 at angles 85° and 75°. Thus, the correlation value should be not less than 0.7 to control the image forming apparatus using the smoothness of a sheet. Therefore, if the correlation value is less than 0.7, measurement of the smoothness of the sheet is insufficient. Accordingly, to use the optical sensor 100 for measurement of the smoothness of the sheet, the angle of incidence θ1 and the angle of detection θ2 are preferably in a range of 80°±5°, that is, 75°≦θ1≦85°.

When the angle of incidence θ1 and the angle of detection θ2 are relatively large (e.g.,) 80°) in the optical sensor 100, detection accuracy may be reduced if the recording sheet 20 and the optical sensor 100 are moved away from each other as illustrated in FIG. 9. A gap between the recording sheet 20 and the focus position Q of the optical sensor 100 may change by several millimeters due to movement of the recording sheet 20 while being conveyed. Preferably, the optical sensor 100 is capable of absorbing changes in gap due to the movement of the recording sheet 20 while being conveyed.

In the present embodiment, the optical sensor 100 positions the lens 121 between the recording sheet 20 and the regular reflection light sensor 130, and therefore can absorb changes in gap between the recording sheet 20 and the focus position Q of the optical sensor 100. The lens 121 between the recording sheet 20 and the regular reflection light sensor 130 focuses the light entering the lens 121 toward the regular reflection light sensor 130 (PD). Specifically, the lens 121 focuses not only light entering the center of the lens 121 but also collimated light entering an effective diameter of the lens 121 toward the regular reflection light sensor 130 (PD). Accordingly, the lens 121 accepts different incident positions of incident light having the same size as the effective diameter of the lens 121.

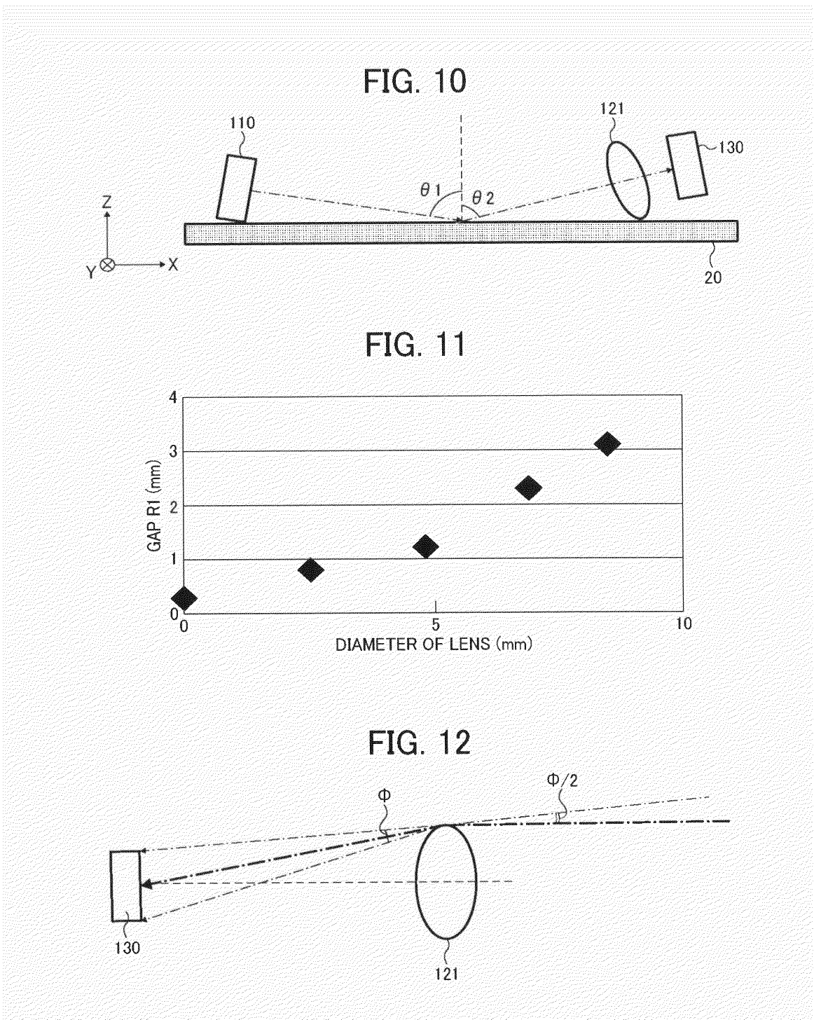

Referring now to FIG. 10, a description is given of the effect of such an arrangement based on an experiment.

FIG. 10 is a schematic view of an experimental device for confirming the advantageous effect of the lens 121.

An LED was used as the light source 110. A collimator lens was used to generate collimated beams with which the recording sheet 20 was irradiated. A lens having a diameter of 3 mm and a focal length (F) of 9 mm was used as the lens 121, which was disposed between the recording sheet 20 and the regular reflection light sensor 130. Through the lens 121, light reflected from the recording sheet 20 entered the regular reflection light sensor 130. The regular reflection light sensor 130 and the lens 121 were disposed such that the light-receiving surface of the regular reflection light sensor 130 was positioned at the focus position of the lens 121.

For the experiment, four lenses 121 having the same numerical aperture but different diameters were prepared. The light strength was measured for each lens 121 incorporated in the optical sensor 100 while varying the gap. A larger gap decreased the light amount, because the recording sheet 20 on which light was reflected was farther from the optical sensor 100.

Referring now to FIG. 11, a description is given of a relationship between the gap and the diameter of the lens 121.

In FIG. 11, a gap R1 indicates a gap that caused the light amount to be 90% at the focus position. The gap R1 depended on the size of the lens 121. FIG. 11 illustrates a correlation between the diameter of the lens 121 and the gap R1. A larger diameter of the lens 121 increased the gap R1. It is to be noted that FIG. 11 also includes an illustration of a lens diameter of 0 mm, which means that the optical sensor 100 did not incorporate the lens 121 for comparison. When the lens diameter was 0 mm, the gap R1 was shorter than 1 mm. On the other hand, the gap R1 was over 1 mm when a lens 121 having a diameter of 5 mm was disposed. Accordingly, the optical sensor 100 incorporating the lens 121 between the recording sheet 20 and the regular reflection light sensor 130 is capable of absorbing changes in gap.

The lens 121 focuses collimated light onto the regular reflection light sensor 130. Ideally, if the regular reflection light sensor 130 is relatively small in area, the regular reflection light sensor 130 collects the collimated light almost exclusively. On the other hand, if the regular reflection light sensor 130 has a finite effective diameter, the regular reflection light sensor 130 also collects light slightly shifted from the collimated light. In the present embodiment, an angle shifted from the collimated light is referred to as a light acceptance angle or simply acceptance angle.

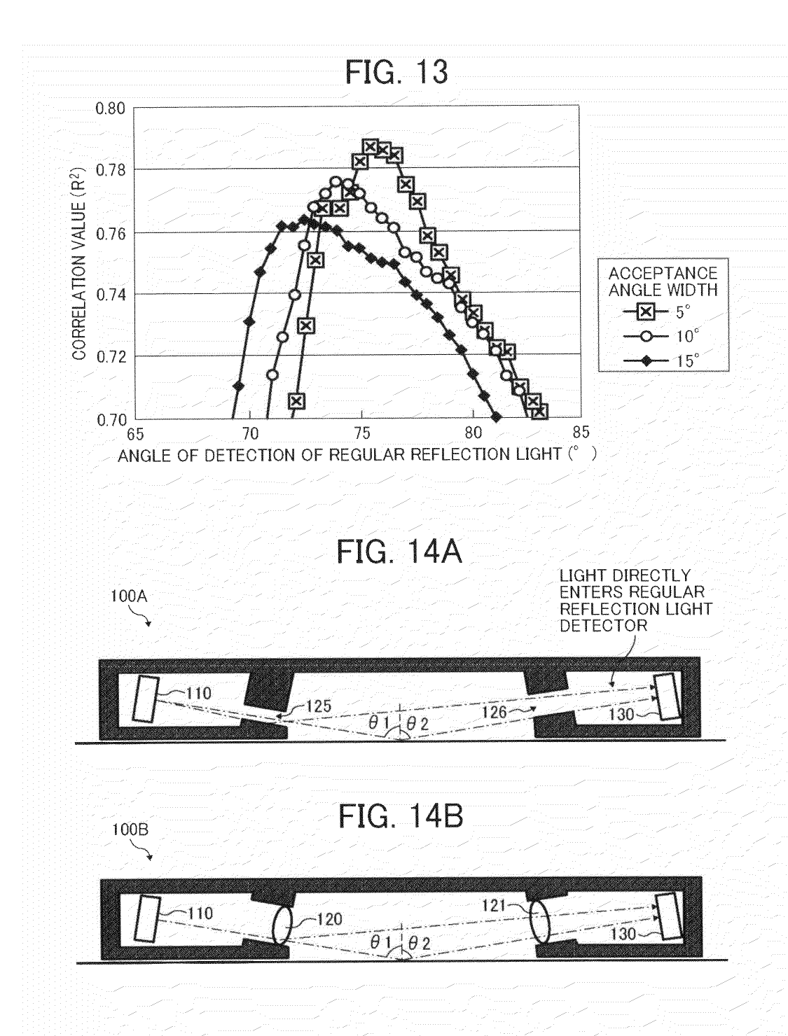

As illustrated in FIG. 12, the acceptance angle width φ is doubled vertically, and therefore, an angle width φ /2 is half the acceptance angle width φ. The acceptance angle width φ depends on the area of the light-receiving surface of the regular reflection light sensor 130 and the focal length (F) of the lens 121. A larger acceptance angle width φ causes an error because the angle of detection θ2 gets larger. In other words, a larger acceptance angle width φ decreases the correlation value as illustrated in FIG. 13.

FIG. 13 is a graph of a relationship between angle of detection of the regular reflection light and correlation value. In FIG. 13, a peak correlation value is about 0.79 when the acceptance angle width φ is 5°. A peak correlation value is over about 0.77 when the acceptance angle width φ is 10°. On the other hand, a peak correlation value is less than about 0.77 when the acceptance angle width φ is 15°. Accordingly, the acceptance angle width φ is preferably not larger than 10°.

For accurate detection with the optical sensor 100, calibration may be needed. In FIGS. 14A and 14B, the angle of incidence θ1 is relatively large and light scattered by the collimator lens 120 or a first aperture 125 directly enters the regular reflection light sensor 130. Specifically, FIG. 14A is a schematic view of an optical sensor 100A employing a configuration in which light scattered by the first aperture 125 enters the regular reflection light sensor 130. FIG. 14B is a schematic view of an optical sensor 100B employing a configuration in which light scattered by the collimator lens 120 enters the regular reflection light sensor 130. It is to be noted that the diffuse reflection light sensor 230 and the lens 240 are omitted for ease of illustration in FIGS. 14A and 14B.

With such a configuration, light emitted by the light source 110 directly enters the regular reflection light sensor 130 without being reflected from the recording sheet 20. In other words, even if the recording sheet 20 is not present, the light from the light source 110 enters the regular reflection light sensor 130, which detects a predetermined light amount. By monitoring the light amount, changes in light amount can be detected when, e.g., the light amount is decreased by paper powder attaching to, e.g., the collimator lens 120. Specifically, the regular reflection light sensor 130 detects a light amount S0 when the recording sheet 20 is not present. Using the light amount S0, a difference (S1−S0) or a ratio (S1/S0) is calculated, where S1 is a light amount obtained when the recording sheet 20 is conveyed and exists at a detection point. Using the difference (S1−S0) or the ratio (S1/S0) calculated, the calibration can be performed. Performing such calibration before detecting the smoothness with the optical sensor 100 leads to accurate detection.

As the optical sensor 100A of FIG. 14A, such an optical sensor 100 may have the light source 110, the first aperture 125, a second aperture 126, and the regular reflection light sensor 130. The light source 110 emits light, which passes through the first aperture 125. The light passing through the first aperture 125 is reflected from the recording sheet 20 and passes through the second aperture 126. The light then enters the regular reflection light sensor 130 that has a detection surface to convert the incident light to an electrical signal. Alternatively, as the optical sensor 100B of FIG. 14B, the optical sensor 100 may have the light source 110, the collimator lens 120, the lens 121, and the regular reflection light sensor 130. The light source 110 emits light, which passes through the collimator lens 120. The light passing through the collimator lens 120 is reflected from the recording sheet 20 and passes through the lens 121. The light then enters the regular reflection light sensor 130 that has a detection surface to convert the incident light to an electrical signal.

Detecting the regular reflection light from the surface of the recording sheet 20 may not be significantly affected by, e.g., light absorption inside the recording sheet 20. However, as a large amount of light is scattered when using a sheet of plain paper as the recording sheet 20, fibers of the recording sheet 20 that absorb light may adversely affect accurate detection of the smoothness even if the angle of detection θ2 is about 80°.

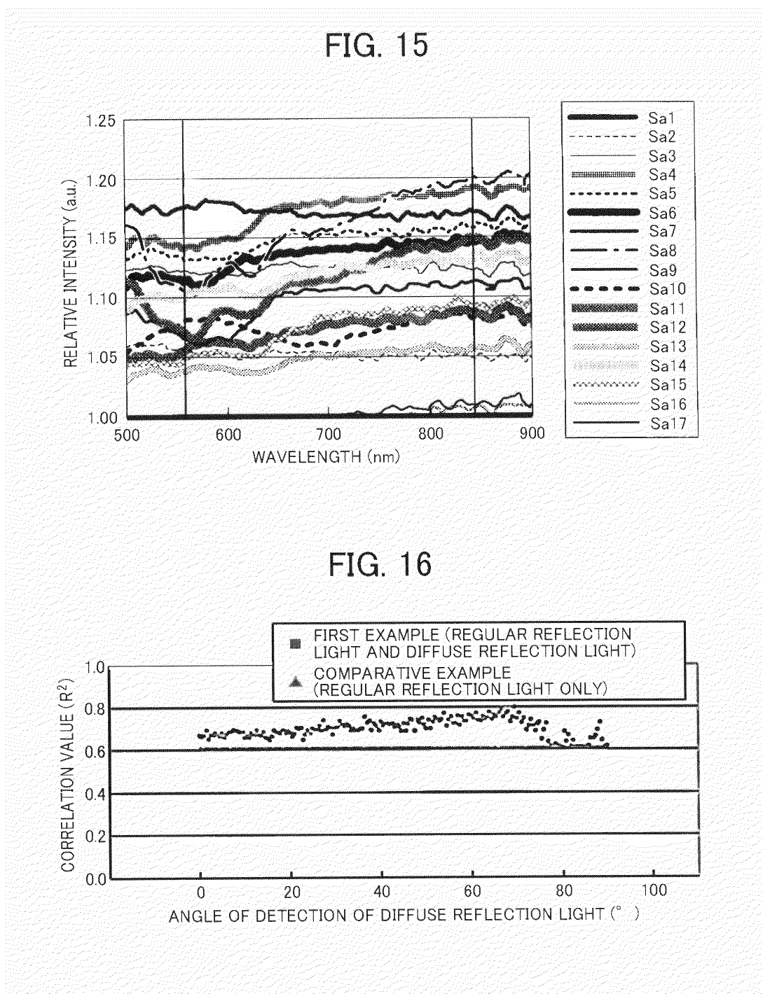

FIG. 15 is a graph of measurement results of reflection spectra of recording sheets. In the measurement, the angle of incidence θ1 was 45°, and the angle of detection θ2 was 0°. A lamp was used as the light source 110. FIG. 15 illustrates measured relative intensity that was standardized to a lowest light amount with respect to 17 kinds of sheets of paper Sa1 through Sa17. As illustrated in FIG. 15, different kinds of sheets have their own amount and kind of fluorescent substance. In addition, the light amount detected changes depending on the wavelengths. Specifically, in a range from about 500 nm to about 750 nm, the light amount detected changes depending on the wavelengths, which also changes an order of the sheets Sa1 through Sa17 with respect to the relative intensity. On the other hand, in a range from about 750 nm, the wavelengths are relatively stable. It is known that the relative intensity in this wavelength range is correlated with the smoothness of the recording sheet 20. In other words, when the light source 110 emits infrared light having a wavelength of about 750 nm or higher, the correlation with the smoothness of the recording sheet 20 can be enhanced.

The regular reflection light received by the regular reflection light sensor 130 is suitable for evaluating mainly the surface condition of the recording sheet 20. However, it may not sufficient to be consistent with the smoothness obtained by the air leakage smoothness test, because the smoothness of the recording sheet 20 may change depending on the conditions of inner air leak near the surface of the recording sheet 20. Hence, in the present embodiment, the smoothness of the recording sheet 20 is accurately measured using not only the amount of regular reflection light received by the regular reflection light sensor 130 but also the amount of diffuse reflection light received by the diffuse reflection light sensor 230.

A description is given of an experiment carried out to compare correlation values between two cases, referred to as a first example and a comparative example in the following description.

In the first example of the present embodiment, the smoothness was detected using the amount of regular reflection light detected by the regular reflection light sensor 130 and the amount of diffuse reflection light detected by the diffuse reflection light sensor 230. In the comparative example, the smoothness was detected using the amount of regular reflection light detected by the regular reflection light sensor 130 only. In the experiment, 30 kinds of sheets of paper were used. The angle of incidence θ1 and the angle of detection θ2 were fixed to 80°.

In the comparative example, a multivariate analysis was conducted from a result of detection by the regular reflection light sensor 130 with respect to the 30 kinds of sheets with the angle of incidence θ1 and the angle of detection θ2 fixed to 80°, to calculate a correlation value between the smoothness obtained from the result of detection by the regular reflection light sensor 130 and the smoothness obtained from the air leakage smoothness test. By contrast, in the first example, a multivariate analysis was conducted from a result of detection by the regular reflection light sensor 130 and a result of detection by the diffuse reflection light sensor 230 with the angle of incidence θ1 and the angle of detection θ2 fixed to 80° and an angle of detection θ3 of the diffuse reflection light detected by the diffuse reflection light sensor 230 changed from 0° to 90° to calculate a correlation value between the smoothness obtained from the results of detection by the regular reflection light sensor 130 and the diffuse reflection light sensor 230 and the smoothness obtained from the air leakage smoothness test.

FIG. 16 is a graph illustrating a comparison of correlation values between the first example and the comparative example. In the graph, the horizontal axis indicates an angle of detection θ3 of the diffuse reflection light. The vertical axis indicates the correlation value.

In the comparative example, the multivariate analysis was conducted from the result of detection by the regular reflection light sensor 130 to optimize constants “d” and “e” in an equation of Y=d×X1+e. The optimum value of the constant “d” was 0.17. On the other hand, the optimum value of the constant “e” was −17.2. The correlation value was 0.61.

By contrast, in the first example, the multivariate analysis was conducted from the results of detection by the regular reflection light sensor 130 and the diffuse reflection light sensor 230 with respect to the 30 kinds of sheets to optimize the constants “a”, “b”, and “c” in the above described Equation I, which is Y=a×X1+b×X2+c. When the angle of detection θ3 was 69.5°, the optimum values of the constants “a”, “b”, and “c” were 0.28, −1.11, and 57.09, respectively. At that time, the correlation value reached its maximum, which was 0.80.

When the angle of detection θ3 was 0°, the optimum values of the constants “a”, “b”, and “c” were 0.16, −0.87, and 18.67, respectively. The correlation value was 0.67. In short, even when the angle of detection θ3 was 0°, a higher correlation value was obtained in the first example than in the comparative example in which the smoothness was detected using the amount of regular reflection light only.

As illustrated in FIG. 16, the larger the angle of detection θ3 gets from 0°, the higher the correlation value is obtained when detecting the smoothness using the amount of regular reflection light and the amount of diffuse reflection light. However, as illustrated in FIG. 16, the correlation value drastically decreases when the angle of detection θ3 gets close to 80°, which is the same as the angle of detection θ2. This is because the diffuse reflection light sensor 230 receives a larger amount of regular reflection light than diffuse reflection light when the angle of detection θ3 of the diffuse reflection light is substantially the same as the angle of detection θ2. Therefore, the appropriate amount of diffuse reflection light is not obtained. In such a case, the results obtained from the regular reflection light sensor 130 and the diffuse reflection light sensor 230 are substantially the same. Accordingly, the correlation value is substantially the same as that in the comparative example in which the smoothness is detected using the amount of regular reflection light only.

As is clear from the above description, when detecting the smoothness using the amount of regular reflection light and the amount of diffuse reflection light, a higher correlation value can be obtained than when detecting the smoothness using the amount of regular reflection light only (correlation value=0.61) or when the angle of detection θ3 of the diffuse reflection light is 0° (correlation value=0.67), if the angle of detection θ3 is set larger than 0° and smaller than the angle of detection θ2 of the regular reflection light. Particularly, if the angle is set in a range to obtain a correlation value of 0.7 or higher, in other words, if the angle is not smaller than 40° and not larger than 75°, the smoothness of a sheet can be measured with sufficient accuracy for controlling the image forming apparatus with the smoothness of the sheet. Preferably, the angle of detection θ3 of the diffuse reflection light is not smaller than 66° and not larger than 70°.

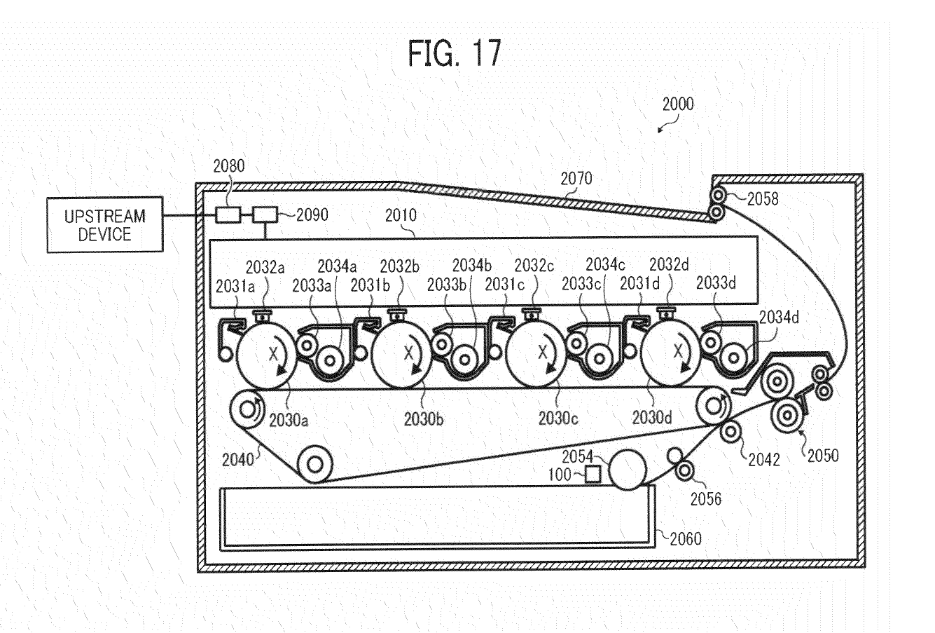

Referring now to FIG. 17, a description is given of an image forming apparatus 2000 that incorporates the optical sensor 100.

FIG. 17 is a schematic view of the image forming apparatus 2000.

In the present embodiment, the image forming apparatus 2000 is a tandem multicolor printer that forms a full-color image on the recording sheet 20 using toner of black, cyan, magenta, and yellow. The image forming apparatus 2000 includes, e.g., an optical scanner 2010, four photoconductive drums 2030a, 2030b, 2030c, and 2030d, four cleaning units 2031a, 2031b, 2031c, and 2031d, four chargers 2032a, 2032b, 2032c, and 2032d, four development rollers 2033a, 2033b, 2033c, and 2033d, four toner cartridges 2034a, 2034b, 2034c, and 2034d, a transfer belt 2040, a transfer roller 2042, a fixing device 2050, a feed roller 2054, a pair of registration rollers 2056, a pair of discharge rollers 2058, a tray 2060, a discharge tray 2070, a communication controller 2080, the optical sensor 100, and a controller 2090 that generally controls the above-described components of the image forming apparatus 2000.

The communication controller 2080 controls communications between the image forming apparatus 2000 and an upstream device such as a personal computer via, e.g., a network.

The controller 2090 includes, e.g., a central processing unit (CPU), a read-only memory (ROM), a random access memory (RAM), an analog-to-digital (AD) converter. The ROM stores a program described in a code decipherable by the CPU and various kinds of data used for executing the program. The RAM is a memory for work. The AD converter converts analog data into digital data. The controller 2090 controls the components of the image forming apparatus 2000 in response to a request from the upstream device while sending image data from the upstream device to the optical scanner 2010.

A station K is constituted of the photoconductive drum 2030a, a charger 2032a, a development roller 2033a, a toner cartridge 2034a, and a cleaning unit 2031a, to form a black image. A station C is constituted of the photoconductive drum 2030b, a charger 2032b, a development roller 2033b, a toner cartridge 2034b, and a cleaning unit 2031b, to form a cyan image. A station M is constituted of the photoconductive drum 2030c, a charger 2032c, a development roller 2033c, a toner cartridge 2034c, and a cleaning unit 2031c, to form a magenta image. A station Y is constituted of the photoconductive drum 2030d, a charger 2032d, a development roller 2033d, a toner cartridge 2034d, and a cleaning unit 2031d, to form a yellow image.

Each of the photoconductive drums 2030 has a photoconductive layer on its surface to be scanned, and is rotated by a rotating mechanism in a direction indicated by arrow X in FIG. 17.

The chargers 2032 uniformly charge the respective surfaces of the photoconductive drums 2030.

According to multicolor image data (black image data, cyan image data, magenta image data, and yellow image data) sent from the upstream device, the optical scanner 2010 irradiates the charged surfaces of the photoconductive drums 2030 with light beams modulated for each color to remove the charge therefrom. Specifically, the charge is removed from the irradiated portion on the surfaces of the photoconductive drums. Accordingly, latent images are formed on the surfaces of the photoconductive drums 2030 according to the respective image data. The latent images thus formed move toward the development rollers 2033 in association with rotation of the respective photoconductive drums 2030.

The toner cartridge 2034a accommodates black toner to supply the black toner to the development roller 2033a. The toner cartridge 2034b accommodates cyan toner to supply the cyan toner to the development roller 2033b. The toner cartridge 2034c accommodates magenta toner to supply the magenta toner to the development roller 2033c. The toner cartridge 2034d accommodates yellow toner to supply the yellow toner to the development roller 2033d.

The surfaces of the development rollers 2033 are thinly and uniformly coated by the toner supplied from the respective toner cartridges 2034 in association with rotation of the development rollers 2033. When the toner coating the surfaces of the development rollers 2033 contacts the respective surfaces of the photoconductive drums 2030, the toner moves and attaches only to the irradiated portion on the surfaces of the photoconductive drums 2030. In short, the development rollers 2033 develop the latent images formed on the surfaces of the photoconductive drums 2030 with toner into visible toner images. The toner images are then transferred onto the transfer belt 2040 in association with rotation of the photoconductive drums 2030.

The toner images of yellow, magenta, cyan, and black are sequentially transferred onto the transfer belt 2040 at a predetermined time such that the toner images are superimposed one atop another to form a multicolor toner image.

The tray 2060 accommodates recording media. The feed roller 2054 is disposed near the tray 2060 to pick up and convey the recording media one at a time to the pair of registration rollers 2056. The pair of registration rollers 2056 sends out the recording medium at a predetermined time toward a contact portion between the transfer belt 2040 and the transfer roller 2042. The multicolor toner image formed on the transfer belt 2040 is transferred onto the recording medium at the nip. The recording medium carrying the multicolor toner image is then conveyed to the fixing device 2050.

The fixing device 2050 applies heat and pressure to the recording medium to fix the multicolor toner image onto the recording medium. Then, the recording medium is conveyed onto the discharge tray 2070 via the pair of discharge rollers 2058. Thus, the recording media are sequentially stacked on the discharge tray 2070.

The cleaning units 2031 remove residual toner from the surfaces of the photoconductive drums 2030. The surfaces of the photoconductive drums 2030 from which the residual toner is removed return to the position where they face the respective chargers 2032.

The optical sensor 100 specifies the type of recording medium accommodated in the tray 2060. In the present embodiment, a three-dimensional Cartesian coordinate system having X, Y, and Z axes is employed. Specifically, a direction perpendicular to the surface of the recording medium is referred to as direction Z, and a surface parallel to the surface of the recording medium is referred to as X-Y surface. The optical sensor 100 is disposed on a +Z side.

It has hitherto been difficult to distinguish between plain paper and matt coated paper using surface data of recording media (data of the amount of regular reflection light) only, which is used in typical identification methods. By contrast, the present embodiment can not only distinguish between plain paper and matt coated paper but also identify a plurality of different types of plain paper as well as a plurality of different types of matt coated paper using the surface data of recording media and inside data of the recording media (data of the amount of diffuse reflection light).

With respect to a plurality of types of recording media that can be handled by the image forming apparatus 2000, the optimum development and transfer conditions are determined in advance for each of the stations K, C, M and Y and for each type of recording media, in an adjustment process or the like prior to shipping. The ROM of the controller 2090 stores a “development and transfer table” that includes the conditions thus determined.

The controller 2090 identifies the type of a recording medium when, e.g., the image forming apparatus 2000 is turned on or the recording medium is supplied to the tray 2060. Specifically, first, the light source 110 of the optical sensor 100 is activated. Then, an amount S1 of regular reflection light and an amount S2 of diffuse reflection light are calculated from output signals from the regular reflection light sensor 130 and the diffuse reflection light sensor 230, respectively. With reference to a recording medium identification table, the type of recording medium is identified from the amount S1 of regular reflection light and the amount S2 of diffuse reflection light obtained. The RAM stores the type of recording medium identified. Thus, the controller 2090 completes identification of the type of recording medium.

When receiving a print job request from, e.g., a user, the controller 2090 reads the type of recording medium stored in the RAM and identifies the optimum development and transfer conditions for the type of recording medium according to the development and transfer table. Then, the controller 2090 controls development devices of the stations K, C, M, and Y and a transfer device according to the optimum development and transfer conditions. For example, the controller 2090 controls a transfer voltage and an amount of toner. Accordingly, a high-quality image is formed on the recording medium.

In the present embodiment, the smoothness of the recording medium can be detected, and therefore, the optimum fixing conditions for the smoothness of the recording medium can be set. Accordingly, the image forming apparatus 2000 is more energy-efficient than a typical image forming apparatus.

The image forming apparatus 2000 includes the single tray 2060. Alternatively, the image forming apparatus 2000 may include a plurality of trays 2060. In such a case, the optical sensor 100 may be provided for each tray 2060.

The optical sensor 100 may identify the type of recording medium during conveyance of the recording medium. In such a case, the optical sensor 100 may be disposed near a conveyance passage defined by internal components of the image forming apparatus 2000. For example, the optical sensor 100 may be disposed near the conveyance passage between the feed roller 2054 and the pair of registration rollers 2056.

In the present embodiment, the image forming apparatus 2000 is described as a color printer. Alternatively, the image forming apparatus 2000 may be an optical plotter or a digital copier.

The image forming apparatus 2000 is also described that includes the four photoconductive drums 2030a, 2030b, 2030c, and 2030d. However, the number of the photoconductive drums 2030 is not limited thereto.

The optical sensor 100 is also applicable to an image forming apparatus that employs an inkjet system to form an image on a recording medium.

Although specific embodiments are described, the configurations of optical sensor and image forming apparatus according to this patent specification is not limited to those specifically described herein. Several aspects of the optical sensor and the image forming apparatus are exemplified as follows.

According to a first aspect of the present embodiment, an optical sensor (e.g., optical sensor 100) includes: a light-emitting unit (e.g., light-emitting unit 101) that emits light onto a measuring object (e.g., recording sheet 20) and includes, e.g., a light source 110 and a collimator lens 120; a regular reflection light receiver (e.g., regular reflection light receiver 102) that receives regular reflection light from the measuring object out of the light emitted by the light-emitting unit and includes, e.g., a regular reflection light sensor 130 and a lens 121; and a diffuse reflection light receiver (e.g., diffuse reflection light receiver 103) that receives diffuse reflection light from the measuring object out of the light emitted by the light-emitting unit and includes, e.g., a diffuse reflection light sensor 230 and a lens 240. An angle of incidence (e.g., angle of incidence θ1) of the light emitted onto a surface of the measuring object is not smaller than 75° and not larger than 85°. The diffuse reflection light receiver receives, out of the diffuse reflection light from the measuring object, diffuse reflection light having an angle of reflection (e.g., angle of detection θ3) with respect to a perpendicular to the surface of the measuring object larger than 0° and smaller than an angle of reflection (e.g., angle of detection θ2) of the regular reflection light with respect to the perpendicular to the surface of the measuring object. In the optical sensor in which the angle of incidence of the light emitted by the light-emitting unit to the surface of the measuring object is not smaller than 75° and not larger than 85°, the larger the angle of reflection of the diffuse reflection light that is used for measurement of smoothness gets from 0° with respect to the perpendicular to the measuring object, the higher the degree of correlation (correlation value) of actual smoothness and smoothness (e.g., smoothness Y) obtained from an amount of regular reflection light and an amount of diffuse reflection light is.

However, if the angle of reflection of the diffuse reflection light that is used for measurement of smoothness with respect to the perpendicular to the measuring object is substantially the same as the angle of reflection of the regular reflection light with respect to the perpendicular to the measuring object, the diffuse reflection light receiver receives a larger amount of regular reflection light than an amount of diffuse reflection light. Therefore, the diffuse reflection light receiver cannot appropriately obtain data of the amount of diffuse reflection light. Substantially, the smoothness is measured with almost the same accuracy as in a configuration for obtaining the smoothness using just the amount of regular reflection light.

According to the present aspect, the diffuse reflection light receiver receives diffuse reflection light having an angle of reflection with respect to the perpendicular to the surface of the measuring object larger than 0° and smaller than the angle of reflection of the regular reflection light with respect to the perpendicular to the measuring object. Accordingly, a higher correlation of the actual smoothness and the smoothness obtained from the amount of regular reflection light and the amount of diffuse reflection light can be obtained than a comparative configuration in which the smoothness is calculated using a received amount of diffuse reflection light having an angle of reflection of 0° with respect to the perpendicular to the measuring object. As a result, the smoothness can be measured with a higher accuracy than in the comparative configuration.

According to a second aspect, the diffuse reflection light receiver receives diffuse reflection light having an angle of reflection not smaller than 66° and not larger than 70° with respect to the perpendicular to the measuring object.

Accordingly, the correlation of the actual smoothness and the smoothness obtained from the amount of regular reflection light and the amount of diffuse reflection light is enhanced to measure the smoothness with a higher accuracy.

According to a third aspect, the diffuse reflection light receiver includes a converging member, such as the lens 240, that collects diffuse reflection light within an angular range of ±2° about the angle of reflection of the diffuse reflection light.

Accordingly, the diffuse reflection light receiver can receive the diffuse reflection light having a desired angle of reflection regardless of a slight change in distance between the light-emitting unit and the measuring object, resulting in stable and accurate measurement of smoothness.

According to a fourth aspect, the light-emitting unit is an infrared light-emitting unit to achieve measurement of smoothness with a higher accuracy.

According to a fifth aspect, the regular reflection light receiver also receives direct light that is not reflected from the surface of the measuring object out of the light emitted by the light-emitting unit.

Accordingly, calibration of the optical sensor is facilitated.

According to a sixth aspect, an image forming apparatus (e.g., image forming apparatus 2000) that forms an image on a recording medium (e.g., recording sheet 20) includes the optical sensor (e.g., optical sensor 100) and a recording medium type identifier (e.g., controller 2090) that identifies a type of recording medium using data provided by the regular reflection light receiver and the diffuse reflection light receiver of the optical sensor.

Accordingly, the image forming apparatus can accurately measure the smoothness of the recording medium with the optical sensor, and therefore, the image forming apparatus can accurately identify the type of recording medium using the difference of smoothness.

According to a seventh aspect, the recording medium type identifier calculates a surface smoothness of the recording medium using the data provided by the regular reflection light receiver and the diffuse reflection light receiver of the optical sensor to identify the type of recording medium.

Accordingly, the image forming apparatus can accurately identify the type of recording medium using the difference of smoothness.

The present invention has been described above with reference to specific exemplary embodiments. It is to be noted that the present invention is not limited to the details of the embodiments described above, but various modifications and enhancements are possible without departing from the scope of the invention. It is therefore to be understood that the present invention may be practiced otherwise than as specifically described herein. For example, elements and/or features of different illustrative exemplary embodiments may be combined with each other and/or substituted for each other within the scope of this invention. The number of constituent elements and their locations, shapes, and so forth are not limited to any of the structure for performing the methodology illustrated in the drawings.

What is claimed is:

1. An optical sensor comprising:
a light-emitting unit to emit light onto a measuring object;
a regular reflection light receiver to receive regular reflection light from the measuring object out of the light emitted by the light-emitting unit; and
a diffuse reflection light receiver to receive diffuse reflection light from the measuring object out of the light emitted by the light-emitting unit,
wherein an angle of incidence of the light emitted onto a surface of the measuring object is not smaller than 75° and not larger than 85°, and
wherein the diffuse reflection light receiver receives, out of the diffuse reflection light from the measuring object, diffuse reflection light having an angle of reflection with respect to a perpendicular to the surface of the measuring object larger than 0° and smaller than an angle of reflection of the regular reflection light with respect to the perpendicular to the surface of the measuring object.

2. The optical sensor according to claim 1, wherein the diffuse reflection light receiver receives diffuse reflection light having an angle of reflection not smaller than 66° and not larger than 70° with respect to the perpendicular to the measuring object.

3. The optical sensor according to claim 1, wherein the diffuse reflection light receiver comprises a converging member that collects diffuse reflection light within an angular range of ±2° about the angle of reflection of the diffuse reflection light.

4. The optical sensor according to claim 1, wherein the light-emitting unit is an infrared light-emitting unit.

5. The optical sensor according to claim 1, wherein the regular reflection light receiver also receives direct light that is not reflected from the surface of the measuring object out of the light emitted by the light-emitting unit.

6. An image forming apparatus comprising:
the optical sensor according to claims 1; and
a recording medium type identifier to identify a type of recording medium using data provided by the regular reflection light receiver and the diffuse reflection light receiver of the optical sensor.

7. The image forming apparatus according to claim 6, wherein the recording medium type identifier calculates a surface smoothness of the recording medium using the data provided by the regular reflection light receiver and the diffuse reflection light receiver of the optical sensor to identify the type of recording medium.
